(19) United States
(12) Patent Application Publication
(10) Pub. No.: US 2024/0078414 A1
(43) Pub. Date: Mar. 7, 2024

(54) PARALLELIZED CONTEXT MODELLING USING INFORMATION SHARED BETWEEN PATCHES

(71) Applicant: HUAWEI TECHNOLOGIES CO., LTD., Shenzhen (CN)

(72) Inventors: Ahmet Burakhan Koyuncu, Munich (DE); Atanas Boev, Munich (DE); Elena Alexandrovna Alshina, Munich (DE)

(21) Appl. No.: 18/507,949

(22) Filed: Nov. 13, 2023

Related U.S. Application Data
(63) Continuation of application No. PCT/EP2021/065394, filed on Jun. 9, 2021.

(51) Int. Cl. G06N 3/0464; G06N 7/01

(52) U.S. Cl. CPC G06N 3/0464; G06N 7/01

(57) ABSTRACT

Methods and apparatuses are provided for entropy encoding and decoding of a latent tensor, which includes separating the latent tensor into patches and obtaining a probability model for the entropy encoding of a current element of the latent tensor by processing a set of elements from different patches by one or more layers of a neural network. The processing of the set of elements by applying a convolution kernel enables sharing of information between the separated patches.

### CROSS-REFERENCE TO RELATED APPLICATIONS

This application is a continuation of International Application No. PCT/EP2021/065394, filed on Jun. 9, 2021, the disclosure of which is hereby incorporated by reference in its entirety.

### TECHNICAL FIELD

Embodiments of the present disclosure relate to the field of artificial intelligence (AI)-based video or picture compression technologies, and in particular, to context modelling using shared information between patches of elements of a latent tensor.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video pictures. The compressed data is then received at the destination by a video decompression device that decodes the video data. With limited network resources and ever increasing demands of higher video quality, improved compression and decompression techniques that improve compression ratio with little to no sacrifice in picture quality are desirable.

In recent years, deep learning is gaining popularity in the fields of picture and video encoding and decoding.

### SUMMARY

The embodiments of the present disclosure provide apparatuses and methods for entropy encoding and decoding of a latent tensor, which includes separating the latent tensor into patches and obtaining a probability model for the entropy encoding of a current element of the latent tensor by processing a set of elements by one or more layers of a neural network.

According to an embodiment, a method is provided for entropy encoding of a latent tensor, comprising: separating the latent tensor into a plurality of patches, each patch including one or more elements; processing the plurality of patches by one or more layers of a neural network, including processing a set of elements which are co-located in a subset of patches by applying a convolution kernel; and obtaining a probability model for the entropy encoding of a current element of the latent tensor based on the processed set of elements.

The application of a convolution kernel on a set of elements co-located within different patches may enable sharing of information between these separated patches. Apart from the information sharing, each patch may be processed independently from processing of other patches. This opens the possibility to perform the entropy encoding in parallel for a plurality of patches.

In an implementation, the subset of patches forms a K×M grid of patches, with K and M being positive integers, at least one of K and M being larger than one; the set of elements has dimensions K×M corresponding to the K×M grid of patches and includes one element per patch within the subset of patches, and the one element is the current element; and said convolution kernel is a two-dimensional B×C convolution kernel, with B and C being positive integers, at least one of B and C being larger than one.

A convolution kernel of this form may enable information sharing between co-located current elements within a subset of patches, e.g. in the spatial domain, and thus improving the performance of the entropy estimation.

In an implementation, the subset of patches forms a K×M grid of patches, with K and M being positive integers, at least one of K and M being larger than one; the set of elements has dimensions L×K×M corresponding to the K×M grid of patches and includes L elements per patch including the current element and one or more previously encoded elements, L being an integer larger than one; and said convolution kernel is three-dimensional A×B×C convolution kernel, with A being an integer larger than one and B and C being positive integers, at least one of B and C being larger than one.

A convolution kernel of this form may enable the sharing of information between co-located current elements and a specified number of co-located previously encoded elements (temporal domain) within a subset of patches and thus improving the performance of the entropy estimation.

For example, the method is further including storing of the previously encoded elements in a historical memory.

Storing previously encoded elements in a storage may provide an improved encoding processing and speed, as the processing flows do not need to be organized in real-time.

In an implementation, the method is further comprising: reordering the elements included in the set of elements which are co-located in the subset of patches by projecting the co-located elements according to a respective patch position within the subset of patches onto a same spatial plane before the processing.

The reordering may allow that mathematical operations such as convolutions are efficiently applicable on the co-located tensor elements.

For example, the convolution kernel is trainable within the neural network.

A trained kernel may provide an improved processing of the elements that are convolved with said kernel, thus enabling a more refined probability model leading to a more efficient encoding and/or decoding.

In an implementation, the method is further comprising: applying a masked convolution to each of the elements included in a patch out of the plurality of patches, which convolutes the current element and subsequent elements in the encoding order within said patch with zero.

Applying a masked convolution ensures, that only previously encoded elements may be processed and thus the coding order is preserved. The masked convolution mirrors the availability of information at the decoding side to the encoding side.

For example, the method is further comprising: entropy encoding the current element into a first bitstream using the obtained probability model.

Using the probability model obtained by processing the subset of elements by applying a convolution kernel may reduce the size of the bitstream.

In an implementation, the method is further comprising including the patch size into the first bitstream.

Signaling the patch size to the decoding side by inclusion into the bitstream, enables a more flexible choice of patch sizes, as other than the predefined patch sizes may also be used.

For example, patches within the plurality of patches are non-overlapping and each patch out of the plurality of patches is of a same patch size.

Non-overlapping patches of the same size may allow for a more efficient processing of the set of elements.

In an implementation, the method is further comprising: padding the latent tensor such that a new size of the latent tensor is a multiple of said same patch size before separating the latent tensor into the plurality of patches.

Padding of the latent tensor enables any latent tensor to be separated into non-overlapping patches of the same size. This enables a uniform processing for all patches and thus an easier and more efficient implementation.

For example, the latent tensor is padded by zeroes.

Padding by zeroes may provide the advantage, that no additional information is added through the padded elements during the processing of the patches, since, e.g. multiplication with zero provides a zero result.

In an implementation, the method is further comprising quantizing the latent tensor before separating into patches.

A quantized latent tensor yields a simplified probability model, thus enabling a more efficient encoding process. Also, such latent tensor is compressed and can be processed with reduced complexity and represented more efficiently within the bitstream.

For example, the method is further comprising selecting the probability model for the entropy encoding using: information of co-located elements that are currently to be encoded, or information of co-located current elements and information of co-located elements that have been previously encoded.

Enabling the selection of the context modelling strategy may allow for better performance during the encoding process and may provide flexibility in adapting the encoded bitstream to the desired application.

In an implementation, the method is further comprising selecting the probability model according to: information about previously encoded elements, and/or an exhaustive search, and/or properties of the first bitstream.

Adapting the selection of the context modelling according to the mentioned options, may yield a higher rate within the bitstream and/or an improved encoding and/or decoding time.

For example, the method is further comprising: hyper-encoding the latent tensor obtaining a hyper-latent tensor; entropy encoding the hyper-latent tensor into a second bitstream; entropy decoding the second bitstream; and obtaining a hyper-decoder output by hyper-decoding the hyper-latent tensor.

Introducing a hyper-prior model may further improve the probability model and thus the coding rate by determining further redundancy in the latent tensor.

In an implementation, the method is further comprising: separating the hyper-decoder output into a plurality of hyper-decoder output patches, each hyper-decoder output patch including one or more hyper-decoder output elements; concatenating a hyper-decoder output patch out of the plurality of hyper-decoder output patches and a corresponding patch out of the plurality of patches before the processing.

The probability model may be further improved by including the hyper-decoder output in the processing of the set of elements that causes the sharing of information between different patches.

For example, the method is further comprising: reordering the hyper-decoder output elements included in the set of elements which are co-located in the subset of patches by projecting the co-located elements onto the same spatial plane.

The reordering may allow that mathematical operations such as convolutions are efficiently applicable on the co-located hyper-decoder output elements.

In an implementation, one or more of the following steps are performed in parallel for each patch out of the plurality of patches: applying the convolution kernel, and entropy encoding the current element.

A parallel processing of the separated patches may result in a faster encoding into the bitstream.

According to an embodiment, a method is provided for encoding image data comprising: obtaining a latent tensor by processing the image data with an autoencoding convolutional neural network; and entropy encoding the latent tensor into a bitstream using a generated probability model according to any of the methods described above.

The entropy coding may be readily and advantageously applied to image encoding, to effectively reduce the data rate, e.g. when transmission or storage of pictures or videos is desired, as the latent tensors for image reconstruction may still have considerable size.

According to an embodiment, a method is provided for entropy decoding of a latent tensor, comprising: initializing the latent tensor with zeroes; separating the latent tensor into a plurality of patches, each patch including one or more elements; processing the plurality of patches by one or more layers of a neural network, including processing a set of elements which are co-located in a subset of patches by applying a convolution kernel; obtaining a probability model for the entropy decoding of a current element of the latent tensor based on the processed set of elements.

The application of a convolution kernel on a set of elements co-located within different patches may enable sharing of information between these separated patches. Apart from the information sharing, each patch may be processed independently from processing of other patches. This opens the possibility to perform the entropy decoding in parallel for a plurality of patches.

In an implementation, the subset of patches forms a K×M grid of patches, with K and M being positive integers, at least one of K and M being larger than one; the set of elements has dimensions K×M corresponding to the K×M grid of patches and includes one element per patch within the subset of patches, and the one element is the current element; and said convolution kernel is a two-dimensional B×C convolution kernel, with B and C being positive integers, at least one of B and C being larger than one.

A convolution kernel of this form may enable information sharing between co-located current elements within a subset of patches, e.g., in the spatial domain, and thus improving the performance of the entropy estimation.

In an implementation, the subset of patches forms a K×M grid of patches, with K and M being positive integers, at least one of K and M being larger than one; the set of elements has dimensions L×K×M corresponding to the K×M grid of patches and includes L elements per patch including the current element and one or more previously encoded elements, L being an integer larger than one; and said convolution kernel is three-dimensional A×B×C convolution kernel, with A being an integer larger than one and B and C being positive integers, at least one of B and C being larger than one.

A convolution kernel of this form may enable the sharing of information between co-located current elements and a specified number of co-located previously decoded elements (temporal domain) within a subset of patches and thus improving the performance of the entropy estimation.

For example, the method is further including storing of the previously decoded elements in a historical memory.

Storing previously encoded elements in a storage may provide an improved decoding processing and speed, as the processing flows do not need to be organized in real-time.

In an implementation, the method is further comprising: reordering the elements included in the set of elements which are co-located in the subset of patches by projecting the co-located elements according to a respective patch position within the subset of patches onto a same spatial plane before the processing.

The reordering may allow that mathematical operations such as convolutions are efficiently applicable on the co-located tensor elements.

For example, the convolution kernel is trainable within the neural network.

A trained kernel may provide an improved processing of the elements that are convolved with said kernel, thus enabling a more refined probability model leading to a more efficient encoding and/or decoding.

In an implementation, the method is further comprising: entropy decoding the current element from a first bitstream using the obtained probability model.

Using the probability model obtained by processing the subset of elements by applying a convolution kernel may reduce the size of the bitstream.

For example, the method is further comprising extracting the patch size from the first bitstream.

Signaling the patch size to the decoding side by inclusion into the bitstream, enables a more flexible choice of patch sizes, as other than the predefined patch sizes may also be used.

In an implementation, patches within the plurality of patches are non-overlapping and each patch out of the plurality of patches is of a same patch size.

Non-overlapping patches of the same size may allow for a more efficient processing of the set of elements.

For example, the method is further comprising: padding the latent tensor such that a new size of the latent tensor is a multiple of said same patch size before separating the latent tensor into the plurality of patches.

Padding of the latent tensor enables any latent tensor to be separated into non-overlapping patches of the same size. This enables a uniform processing for all patches and thus an easier and more efficient implementation.

For example, the latent tensor is padded by zeroes.

Padding by zeroes may provide the advantage, that no additional information is added through the padded elements during the processing of the patches, since, e.g. multiplication with zero provides a zero result.

In an implementation, the method is further comprising determining the probability model for the entropy decoding using: information of co-located elements that are currently to be decoded, or information of co-located current elements and information of co-located elements that have been previously decoded.

Enabling the determination of the context modelling strategy may allow for better performance during the decoding process.

For example, the method is further comprising determining the probability model according to: information about previously decoded elements, and/or properties of the first bitstream.

The determined context modelling strategy may enable a higher rate within the bitstream and/or an improved decoding time.

In an implementation, the method is further comprising: entropy decoding a hyper-latent tensor from a second bitstream; and obtaining a hyper-decoder output by hyper-decoding the hyper-latent tensor.

Introducing a hyper-prior model may further improve the probability model and thus the coding rate by determining further redundancy in the latent tensor.

For example, the method is further comprising: separating the hyper-decoder output into a plurality of hyper-decoder output patches, each hyper-decoder output patch including one or more hyper-decoder output elements; concatenating a hyper-decoder output patch out of the plurality of hyper-decoder output patches and a corresponding patch out of the plurality of patches before the processing.

The probability model may be further improved by including the hyper-decoder output in the processing of the set of elements that causes the sharing of information between different patches.

In an implementation, the method is further comprising: reordering the hyper-decoder output elements included in the set of elements which are co-located in the subset of patches by projecting the co-located elements onto the same spatial plane.

The reordering may allow that mathematical operations such as convolutions are efficiently applicable on the co-located hyper-decoder output elements.

In an implementation, one or more of the following steps are performed in parallel for each patch out of the plurality of patches: applying the convolution kernel, and entropy decoding the current element.

A parallel processing of the separated patches may result in a faster decoding into the bitstream.

According to an embodiment, a method is provided for decoding image data comprising: entropy decoding a latent tensor from a bitstream according to any of the methods described above; and obtaining the image data by processing the latent tensor with an autodecoding convolutional neural network.

The entropy decoding may be readily and advantageously applied to image decoding, to effectively reduce the data rate, e.g. when transmission or storage of pictures or videos is desired, as the latent tensors for image reconstruction may still have considerable size.

In an implementation, a computer program stored on a non-transitory medium and including code instructions, which, when executed on one or more processors, cause the one or more processors to execute steps of the method according to any of the methods described above.

According to an embodiment, an apparatus is provided for entropy encoding of a latent tensor, comprising: processing circuitry configured to: separate the latent tensor into a plurality of patches, each patch including one or more elements; process the plurality of patches by one or more layers of a neural network, including processing a set of elements which are co-located in a subset of patches by applying a convolution kernel; and obtain a probability model for the entropy encoding of a current element of the latent tensor based on the processed set of elements.

According to an embodiment, an apparatus is provided for entropy decoding of a latent tensor, comprising: processing circuitry configured to: initialize the latent tensor with zeroes; separate the latent tensor into a plurality of patches, each patch including one or more elements; process the plurality of patches by one or more layers of a neural network, including processing a set of elements which are co-located in a subset of patches by applying a convolution kernel; obtain a probability model for the entropy decoding of a current element of the latent tensor based on the processed set of elements.

The apparatuses provide the advantages of the methods described above.

The invention can be implemented in hardware (HW) and/or software (SW) or in any combination thereof. Moreover, HW-based implementations may be combined with SW-based implementations.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the invention are described in more detail with reference to the attached figures and drawings, in which:

FIG. 1 is a schematic drawing illustrating channels processed by layers of a neural network;

FIG. 2 is a schematic drawing illustrating an autoencoder type of a neural network;

FIG. 3a is a schematic drawing illustrating a network architecture for encoder and decoder side including a hyperprior model;

FIG. 3b is a schematic drawing illustrating a general network architecture for encoder side including a hyperprior model;

FIG. 3c is a schematic drawing illustrating a general network architecture for decoder side including a hyperprior model;

FIG. 4 is a schematic illustration of a latent tensor obtained from an input image;

FIG. 5 shows masked convolution kernels;

FIG. 6 is a schematic drawing illustrating a network architecture for encoder and decoder side including a hyperprior model and context modelling;

FIG. 7 shows an application of a masked convolution kernel to a latent tensor;

FIG. 8 shows a separation of a latent tensor into patches and the application of masked convolution kernels to the patches;

FIG. 9 illustrates the padding of the latent tensor and the separation of the padded tensor into patches of the same size;

FIG. 10 is a schematic drawing illustrating a context modeling including the sharing of information between patches;

FIG. 11 illustrates the reordering of patches and the application of a convolution kernel;

FIG. 12a shows a serial processing of a latent tensor;

FIG. 12b shows a parallel processing of a latent tensor;

FIG. 13a illustrates the information sharing using information of current co-located latent tensor elements;

FIG. 13b illustrates the information sharing using information of current and previous co-located latent tensor elements;

FIG. 14 is a block diagram showing an example of a video coding system configured to implement embodiments of the invention.

FIG. 15 is a block diagram showing another example of a video coding system configured to implement embodiments of the invention.

FIG. 16 is a block diagram illustrating an example of an encoding apparatus or a decoding apparatus.

FIG. 17 is a block diagram illustrating another example of an encoding apparatus or a decoding apparatus.

### DETAILED DESCRIPTION

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps is described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various embodiments and/or aspects described herein may be combined with each other, unless specifically noted otherwise.

Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

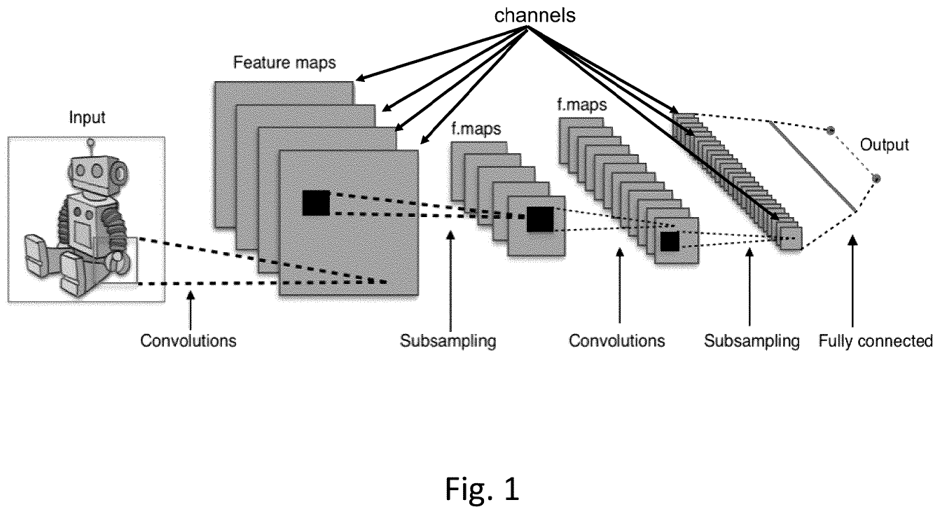

FIG. 1 schematically illustrates a general concept of processing by a neural network such as the CNN. A convolutional neural network consists of an input and an output layer, as well as multiple hidden layers. Input layer is the layer to which the input (such as a portion of an image as shown in FIG. 1) is provided for processing. The hidden layers of a CNN typically consist of a series of convolutional layers that convolve with a multiplication or other dot product. The result of a layer is one or more feature maps (f.maps in FIG. 1), sometimes also referred to as channels. There may be a subsampling involved in some or all of the layers. As a consequence, the feature maps may become smaller, as illustrated in FIG. 1. The activation function in a CNN is usually a ReLU (Rectified Linear Unit) layer, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). Then after passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers, it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or [symbol] 2-norm pooling. Average pooling was often used historically but has recently fallen out of favor compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer, which processes input data, e.g. an image, the number of input channels is normally equal to the number of channels of data representation, for instance 3 channels for RGB or YUV representation of images or video, or 1 channel for grayscale image or video representation.

Autoencoders and Unsupervised Learning

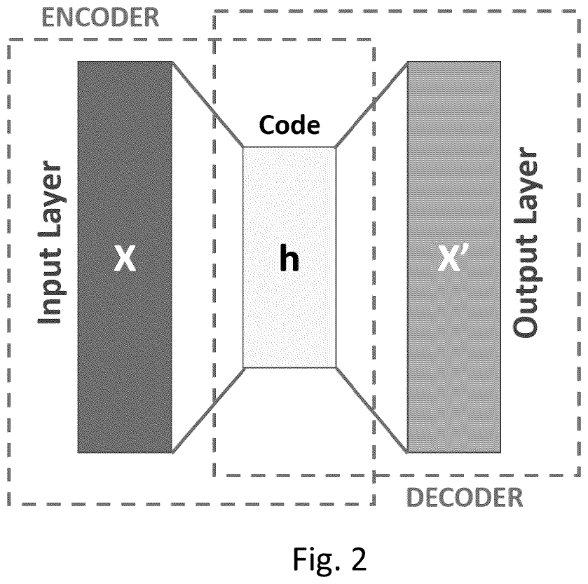

An autoencoder is a type of artificial neural network used to learn efficient data codings in an unsupervised manner. A schematic drawing thereof is shown in FIG. 2. The aim of an autoencoder is to learn a representation (encoding) for a set of data, typically for dimensionality reduction, by training the network to ignore signal “noise”. Along with the reduction side, a reconstructing side is learnt, where the autoencoder tries to generate from the reduced encoding a representation as close as possible to its original input, hence its name. In the simplest case, given one hidden layer, the encoder stage of an autoencoder takes the input x and maps it to h

h=σ(Wx+b).

This image h is usually referred to as code, latent variables, or latent representation. Here, α is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

x′=σ′(W′h+b′)

where σ′, W′ and b′ for the decoder may be unrelated to the corresponding α, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate—distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

Variational Image Compression

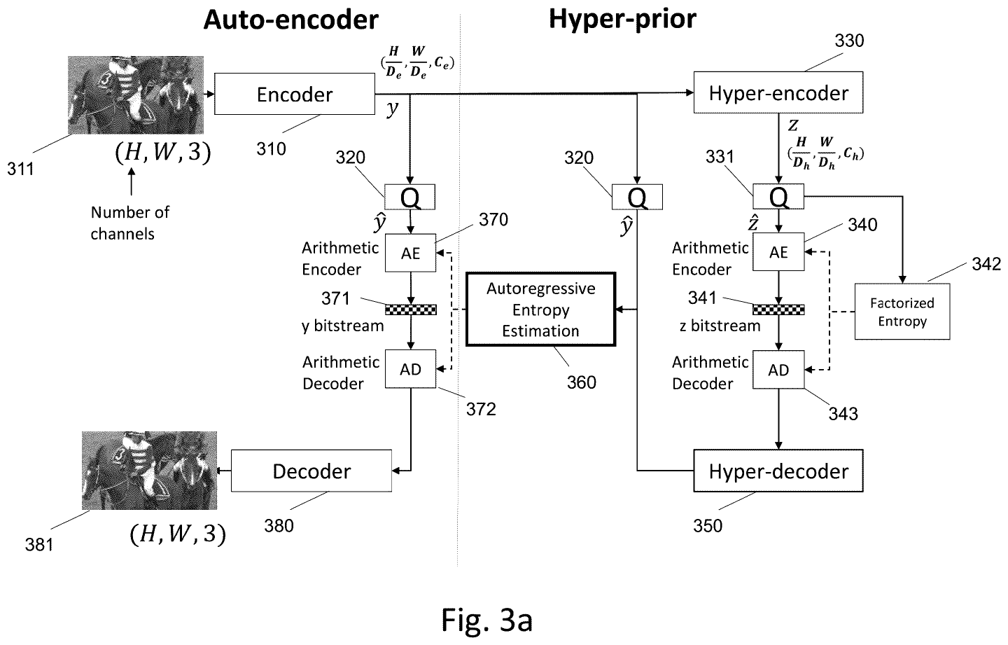

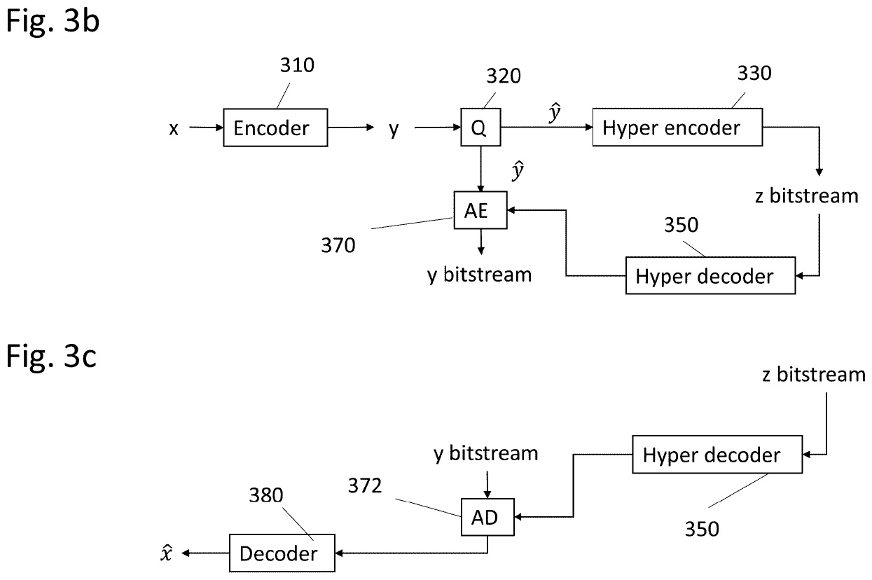

Variable Auto-Encoder (VAE) framework can be considered as a nonlinear transforming coding model. The transforming process can be mainly divided into four parts: FIG. 3a shows the VAE framework. In FIG. 3a, the encoder 310 maps an input image x 311 into a latent representation (denoted by y) via the function y=f(x). This latent representation may also be referred to as a part of or a point within a “latent space” in the following. The function f( ) is a transformation function that converts the input signal 311 into a more compressible representation y.

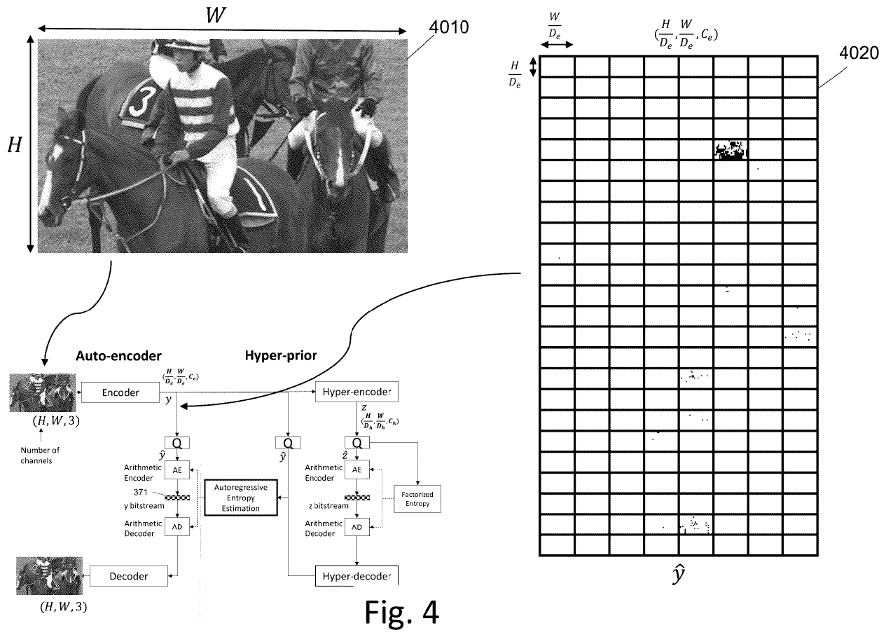

The input image 311 to be compressed is represented as a 3D tensor with the size of H×W×C, where H and W are the height and width of the image and C is the number of color channels. In a first step, the input image is passed through the encoder 310. The encoder 310 down-samples the input image 311 by applying multiple convolutions and non-linear transformations, and produces a latent-space feature tensor (latent tensor in the following) y. (While this is not a re-sampling in the classical sense, in deep learning down and up-sampling are common terms for changing the size of height and width of the tensor). The latent tensor y 4020 corresponding to the input image 4010, shown in FIG. 4, has the size of

$$\frac{H}{{D}_{e}} \times \frac{W}{{D}_{e}} \times {C}_{e} ,$$

whereas Dₑ is the down-sampling factor of the encoder and Cₑ is the number of channels.

The difference between the pixels of an input/output image and the latent tensor are shown in FIG. 4. The latent tensor 4020 is a multi-dimensional array of elements, which typically do not represent picture information. Two of the dimensions are associated to the height and width of the image, and information and the contents are related to lower resolution representation of the image. The third dimension, i.e. the channel dimension is related to the different representations of the same image in the latent space.

The latent space can be understood as a representation of compressed data in which similar data points are closer together in the latent space. Latent space is useful for learning data features and for finding simpler representations of data for analysis. The quantizer 330 transforms the latent representation ŷ into the quantized latent representation ŷ with (discrete) values by ŷ=Q(y), with Q representing the quantizer function.

The entropy estimation of the latent tensor y may be improved by additionally applying an optional hyper-prior model.

In the first step of obtaining a hyper-prior model, a hyper-encoder 320 is applied to the latent tensor y, which down-samples the latent tensor with convolutions and non-linear transforms into a hyper-latent tensor z. The latent tensor z has the size of

$$\frac{H}{{D}_{h}} \times \frac{W}{{D}_{h}} \times {C}_{h} .$$

In the next step, a quantization 331 may be performed on the latent tensor z. A factorized entropy model 342 produces an estimation of the statistical properties of the quantized hyper-latent tensor \hat{z}. An arithmetic encoder uses these statistical properties to create a bitstream representation 141 of the tensor \hat{z}. All elements of tensor \hat{z} are written into the bitstream without the need of an autoregressive process.

The factorized entropy model 342 works as a codebook whose parameters are available on the decoder side. An entropy decoder 343 recovers the quantized hyper-latent tensor from the bitstream 341 by using the factorized entropy model 342. The recovered quantized hyper-latent tensor is up-sampled in the hyper-decoder 350 by applying multiple convolution operations and non-linear transformations. The hyper-decoder output tensor 430 is denoted by ψ.

The hyper-encoder/decoder (also known as hyper-prior) 330-350 estimates the distribution of the quantized latent representation ŷ to get the minimum rate achievable with a lossless entropy source coding. Furthermore, a decoder 380 is provided that transforms the quantized latent representation to the reconstructed image \hat{x} 381, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes y bitstream and z bitstream shown in FIG. 3a, which are generated by the encoder and transmitted to the decoder. Normally, the higher the amount of side information, the higher the reconstruction quality. However, a high amount of side information means that the compression ratio is low. Therefore, one purpose of the system described in FIG. 3a is to balance the reconstruction quality and the amount of side information conveyed in the bitstream.

In FIG. 3a the component AE 370 is the Arithmetic Encoding module, which converts samples of the quantized latent representation ŷ and the side information \hat{z} into binary representations, y bitstream and z bitstream respectively. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 372 is the process of reverting the binarization process, where binary digits are converted back to sample values. The arithmetic decoding is provided by the arithmetic decoding module 372.

In FIG. 3a there are two sub networks concatenated to each other. A subnetwork in this context is a logical division between the parts of the total network. For example, in FIG. 3a the modules 310, 320, 370, 372 and 380 are called the “Encoder/Decoder” subnetwork. The “Encoder/Decoder” subnetwork is responsible for encoding (generating) and decoding (parsing) of the first bitstream “y bitstream”. The second network in FIG. 3a comprises modules 330, 331, 340, 343, 350 and 360 and is called “hyper encoder/decoder” subnetwork. The second subnetwork is responsible for generating the second bitstream “z bitstream”. The purposes of the two subnetworks are different.

The first subnetwork is responsible for:
the transformation 310 of the input image 311 into its latent representation ŷ (which is easier to compress that x),
quantizing 320 the latent representation ŷ into a quantized latent representation ŷ,
compressing the quantized latent representation ŷ using the AE by the arithmetic encoding module 370 to obtain bitstream “y bitstream”,”.
parsing the y bitstream via AD using the arithmetic decoding module 372, and
reconstructing 380 the reconstructed image 381 using the parsed data.

The purpose of the second subnetwork is to obtain statistical properties (e.g. mean value, variance and correlations between samples of y bitstream) of the samples of “y bitstream”, such that the compressing of y bitstream by first subnetwork is more efficient. The second subnetwork generates a second bitstream “z bitstream”, which comprises the said information (e.g. mean value, variance and correlations between samples of y bitstream).

The second network includes an encoding part which comprises transforming 330 of the quantized latent representation ŷ into side information z, quantizing the side information z into quantized side information \hat{z}, and encoding (e.g. binarizing) 340 the quantized side information \hat{z} into z bitstream. In this example, the binarization is performed by an arithmetic encoding (AE). A decoding part of the second network includes arithmetic decoding (AD) 343, which transforms the input z bitstream into decoded quantized side information \hat{z}. The \hat{z}′ might be identical to \hat{z}, since the arithmetic encoding and decoding operations are lossless compression methods. The decoded quantized side information \hat{z}′ is then transformed 350 into decoded side information ŷ′. ŷ′ represents the statistical properties of y̅ (e.g. mean value of samples of ŷ, or the variance of sample values or like). The decoded latent representation ŷ′ is then provided to the above-mentioned Arithmetic Encoder 370 and Arithmetic Decoder 372 to control the probability model of ŷ.

The FIG. 3a describes an example of VAE (variational auto encoder), details of which might be different in different implementations. For example in a specific implementation additional components might be present to more efficiently obtain the statistical properties of the samples of the first bitstream. In one such implementation a context modeler might be present, which targets extracting cross-correlation information of the y bitstream. The statistical information provided by the second subnetwork might be used by AE (arithmetic encoder) 370 and AD (arithmetic decoder) 372 components.

FIG. 3a depicts the encoder and decoder in a single figure. As is clear to those skilled in the art, the encoder and the decoder may be, and very often are, embedded in mutually different devices.

FIG. 3b depicts the encoder and FIG. 3c depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3b) is a y bitstream and a z bitstream. The y bitstream is the output of the first sub-network of the encoder and the z bitstream is the output of the second subnetwork of the encoder.

Similarly, in FIG. 3c, the two bitstreams, y bitstream and z bitstream, are received as input and \hat{z}, which is the reconstructed (decoded) image, is generated at the output. As indicated above, the VAE can be split into different logical units that perform different actions. This is shown in FIGS. 3b and 3c so that FIG. 3b depicts components that participate in the encoding of a signal, like a video and provided encoded information. This encoded information is then received by the decoder components depicted in FIG. 3c for encoding, for example. It is noted that the components of the encoder and decoder denoted with may correspond in their function to the components referred to above in FIG. 3a.

Specifically, as is seen in FIG. 3b, the encoder comprises the encoder 310 that transforms an input x into a signal y which is then provided to the quantizer 320. The quantizer 320 provides information to the arithmetic encoding module 370 and the hyper-encoder 330. The hyper-encoder 330 may receive the signal y instead of the quantized version. The hyper-encoder 330 provides the z bitstream already discussed above to the hyper-decoder 350 that in turn provides the information to the arithmetic encoding module 370. The substeps as discussed above with reference to FIG. 3a may also be part of this encoder.

The output of the arithmetic encoding module is the y bitstream. The y bitstream and z bitstream are the output of the encoding of the signal, which are then provided (transmitted) to the decoding process. Although the unit 310 is called “encoder”, it is also possible to call the complete subnetwork described in FIG. 3b “encoder”. The process of encoding in general means the unit (module) that converts an input to an encoded (e.g. compressed) output. It can be seen from FIG. 3b, that the unit 310 can be actually considered as a core of the whole subnetwork, since it performs the conversion of the input x into y, which is the compressed version of the x. The compression in the encoder 310 may be achieved, e.g. by applying a neural network, or in general any processing network with one or more layers. In such network, the compression may be performed by cascaded processing including downsampling, which reduces size and/or number of channels of the input. Thus, the encoder may be referred to, e.g. as a neural network (NN) based encoder, or the like.

The remaining parts in the figure (quantization unit, hyper-encoder, hyper-decoder, arithmetic encoder/decoder) are all parts that either improve the efficiency of the encoding process or are responsible for converting the compressed output y into a series of bits (bitstream). Quantization may be provided to further compress the output of the NN encoder 310 by a lossy compression. The AE 370 in combination with the hyper-encoder 330 and hyper-decoder 350 used to configure the AE 370 may perform the binarization, which may further compress the quantized signal by a lossless compression. Therefore, it is also possible to call the whole subnetwork in FIG. 3b an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some implementations may provide an encoder which reduces size only in one (or in general a subset of) dimension.

The arithmetic encoder and decoder are specific implementations of entropy coding. AE and AD can be replaced by any other means of entropy coding. Also, the quantization operation and a corresponding quantization unit is not necessarily present and/or can be replaced with another unit.

Autoregressive Context Modelling

The entropy estimation 360 of the latent tensor y may be improved by additionally applying an optional hyper-prior model as discussed above.

The quantized latent tensor ŷ may be concatenated with the optional output of the hyper-decoder and entropy of the quantized latent tensor ŷ is estimated autoregressively. The autoregressive entropy model 360 produces an estimation of the statistical properties of quantized latent tensor ŷ. An entropy encoder 370 uses these statistical properties to create a bitstream representation 371 of the tensor 9.

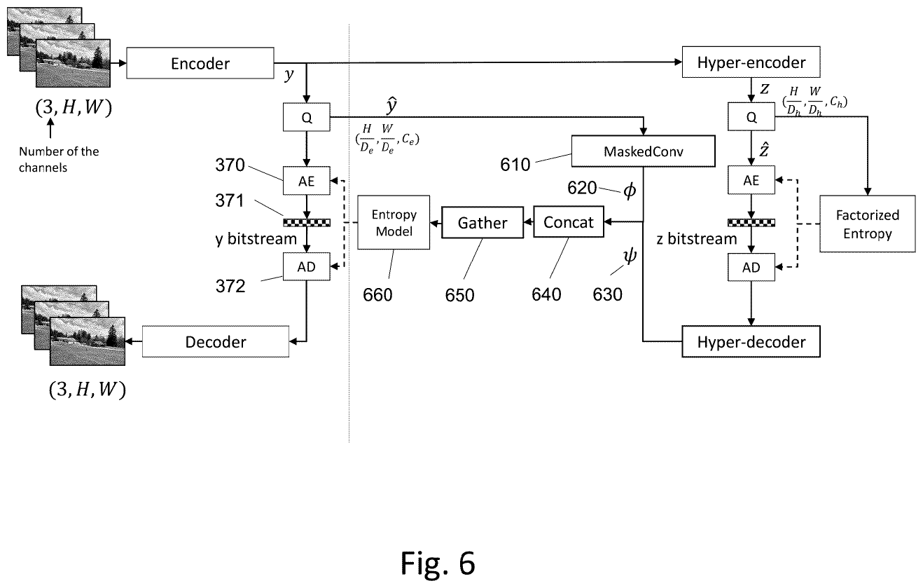

The autoregressive entropy estimation 360 may include the substeps of applying a masked convolution, concatenating the masked latent tensor ŷ with the output of the hyper-decoder ψ, gathering and entropy modelling, which are explained in the following with respect to FIG. 6.

During encoding, the latent tensor elements of ŷ are simultaneously available and masked convolutions 610 guarantee that the causality of the coding sequence is not disturbed. Therefore, the entropy estimation can be done in parallel for each elements of ŷ. The output tensor of masked convolutions 620 is denoted by ϕ.

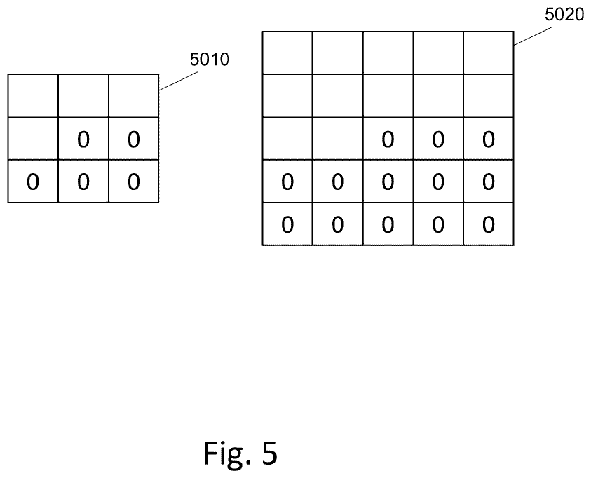

Two masked convolutions, which may be used in context modeling, are depicted in FIG. 5 for different kernel sizes, where the zero values of the kernel are masking the unseen area of the latent tensor. However, the present invention is not limited to a 3×3 masked convolution 5010 or a S×S masked convolution 5020. Any m×n masked convolution kernel with m and n being positive integers may be used.

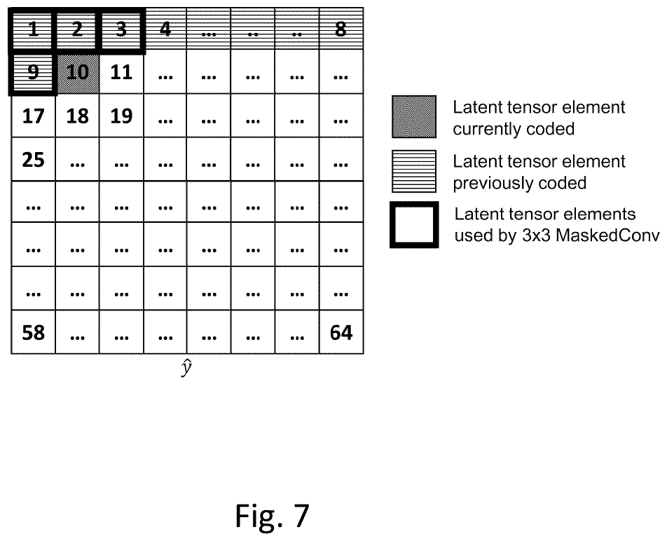

FIG. 7 shows the application of a 3×3 masked convolution 5010 to the 10^{th} latent tensor element. The 1^{st} to 9^{th} latent tensor elements have been previously coded. Such a masked convolution uses the 1^{st}, 2^{nd}, 3^{rd} and 9^{th} latent tensor elements.

The entropy decoder 372 is agnostic to the latent tensor ŷ and its statistical properties. Therefore, during the decoding, the context modelling starts with a blank latent tensor where every latent tensor element is set to zero. By using the statistics of the initial zeros (optionally concatenated with the hyper-decoder output ψ 630), the entropy decoder 372 recovers the first elements. Each i-th element of ŷ is sequentially recovered by using the previously decoded elements. During decoding, steps of entropy estimation 360 and entropy decoding 372 are repeated for each element in ŷ in autoregressive fashion. This results in a total of

$$\frac{H W}{{D}_{e}^{2}}$$

sequential steps.

In a next step, the output tensor of masked convolutions ϕ 620 and the optional output of the hyper-decoder ψ 630 may be concatenated in the channel dimension resulting in a concatenated 3D tensor with the size of

$$\frac{H}{{D}_{e}} \times \frac{W}{{D}_{e}} \times ( {C}_{ϕ} + {C}_{ψ} ) ,$$

where C_{ϕ} and C_{ψ} are the number of channels of the tensors ϕ and ψ, respectively.

The result of the concatenation may be processed by a gathering process 650, which may contain one or several layers of convolutions with 1×1 kernel size and non-linear transformation(s). The entropy model 660 produces an estimation of the statistical properties of the quantized latent tensor ŷ. The entropy encoder 370 uses these statistical properties to create a bitstream representation 371 of the tensor ŷ.

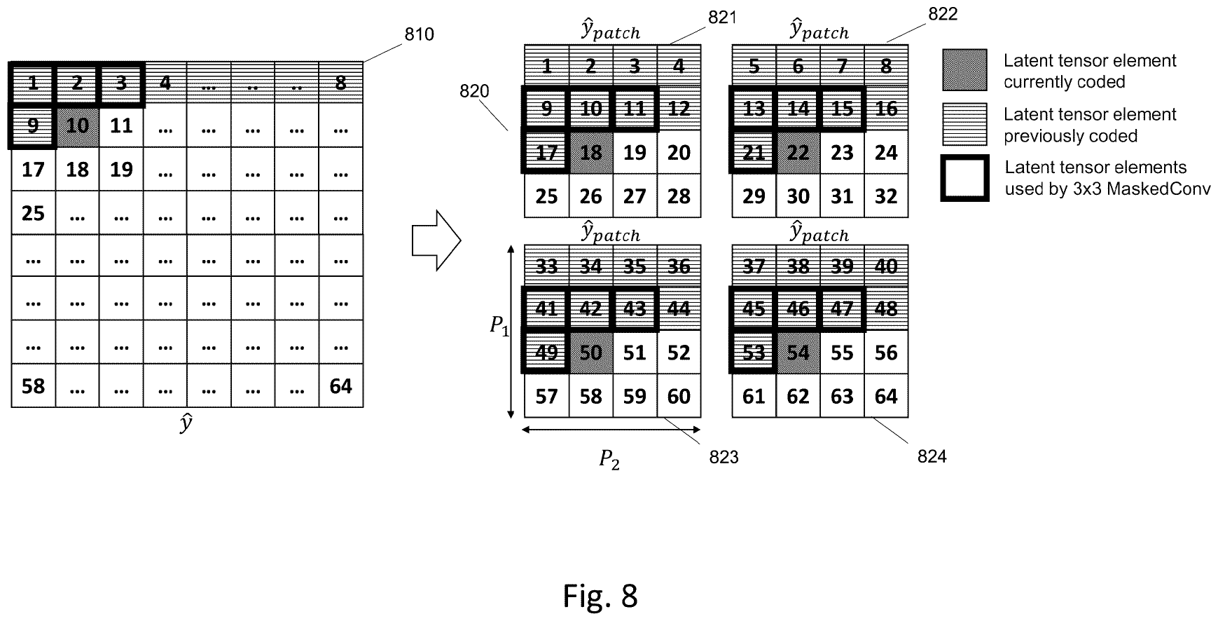

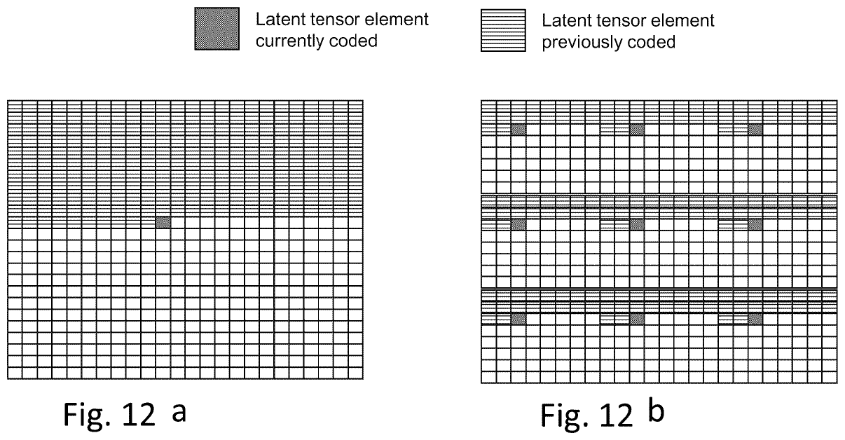

The context modelling method and the entropy encoding as discussed above may be performed sequentially for each element of the latent-space feature tensor. This is shown in FIG. 12a, which shows the single current element and all previous elements in coding order as well as in the ordering within the latent tensor. In order to decrease decoding time, the latent tensor 810 may be split into patches 820 as depicted in FIG. 8. Said patches may be processed in parallel. The illustration in FIG. 12b shows nine patches, each patch including a current element and previous elements in the coding order within each patch. The patch size limits, which latent tensor elements can be used for context modelling.

The example in FIG. 8 separates the 64 elements of the latent tensor into four patches 821-824. Thus, there are four co-located elements, one within each patch, which may be processed in parallel, namely the elements 18, 22, 50 and 54. The elements are processed by applying a 3×3 masked convolution kernel. The masked convolution applied to latent tensor element 18 in the first patch 821 takes into account the previously encoded elements 9, 10, 11 and 17; the masked convolution applied to element 22 in the second patch 822 takes into account the elements 13, 14, 15 and 21 and so on for the third patch 823 and the fourth patch 824. However, sharing information between patches is not possible in this implementation. For example, latent tensor element 21 does not receive information from latent tensor elements within the first patch 821.

Context Modelling Using Information Sharing Between Patches

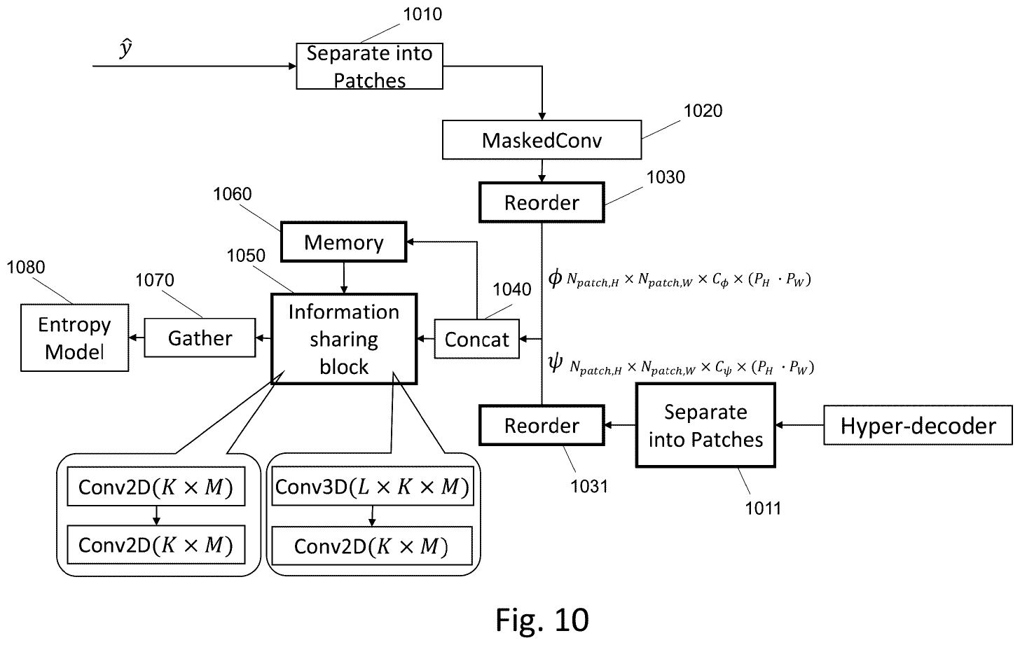

The process of obtaining a context model including information sharing between different patches is shown in FIG. 10. As indicated above, for a possible parallelization, the latent-space feature tensor, which includes one or more elements, is separated into a plurality of patches 1010. Each patch includes one or more latent tensor elements. Such a plurality of patches is processed by one or more layers of a neural network. The patches may be non-overlapping and each patch out of the plurality of patches may be of a same patch size P_{H}×P_{W}, where P_{H} is the height of the patch, and P_{W} is the width of the patch. The total number of patches can be calculated as:

$${N}_{patch , H} = \frac{\frac{H}{{D}_{e}}}{{P}_{H}} = \frac{H}{{P}_{H} {D}_{e}} , {N}_{patch , W} = \frac{\frac{W}{{D}_{e}}}{{P}_{W}} = \frac{W}{{P}_{W} {D}_{e}} ,$$

whereas N_{patch,H} is the number of patches in vertical direction, and N_{patch,W} is the number of patches in horizontal direction, D e is the down-sampling factor of the encoder and H and W are the height and width of the image. The patches form a N_{patch,H}×N_{patch,W} grid. The latent tensor separated into patches is a four-dimensional tensor having dimensions N_{patch,H}×N_{patch,W}×C_{ϕ}×(P_{H}·P_{W}).

In order to obtain patches of the same size the latent tensor may be padded such that the new size of the latent tensor is a multiple of the patch size before separating the latent tensor into patches. The padding may be added, for example, to the right and to the bottom of the tensor. The number of the elements may be calculated as:

$${H}_{pad} = ⌈ \frac{H}{{D}_{e} {P}_{H}} ⌉ * {P}_{H} - \frac{H}{{D}_{e}} , {W}_{pad} = ⌈ \frac{W}{{D}_{e} {P}_{W}} ⌉ * {P}_{W} - \frac{W}{{D}_{e}} ,$$

where ┌x┐ is the ceiling function, which maps x to the least integer greater than or equal to x. However, the present disclosure is not limited to such padding. Alternatively, or in addition, the padding rows and/or columns of feature elements may be added on the top and/or to the left, respectively.

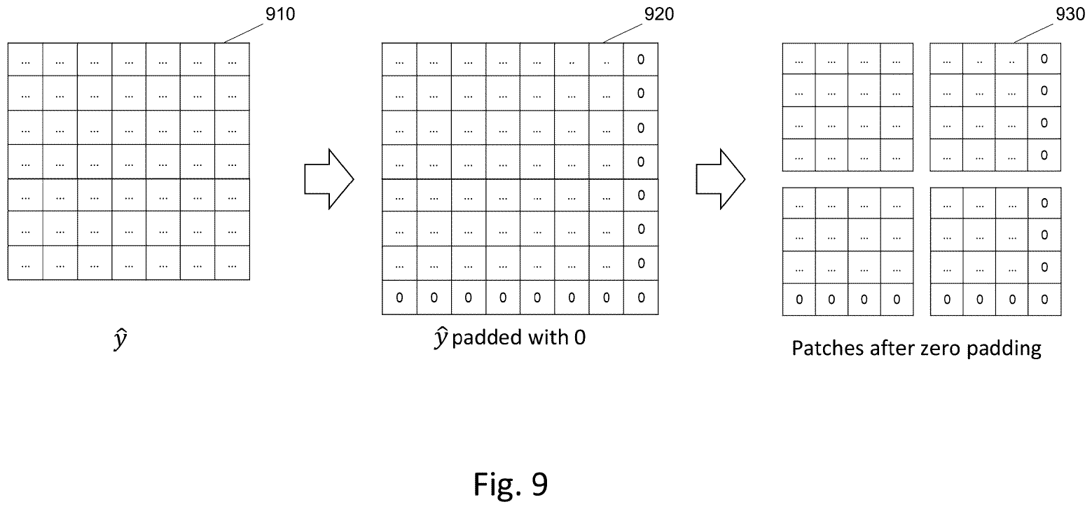

The latent tensor may be padded with zeroes. In the example of FIG. 9, a 7×7 latent tensor 910 is padded with one row and one column of zeroes before splitting the padded latent tensor 920 into four patches 930 of the size 4×4. Padding by zeros is merely one option. Padding may be performed by bits or symbols of any value. It may be padded by a repetition of latent tensor elements, or the like. Nevertheless, padding with zeros provides an advantage that the padded feature elements do not contribute to and thus do not distort the result of convolutions.

Given the original image size H and W, and the patch size, the size of the area which should be padded can be calculated on the decoder side in a similar way as at the encoder side. In order for decoder to work properly, additionally to H and W, the patch size may be signaled to the decoder by including the patch size into the y bitstream.

Before separating the latent tensor into patches, the latent tensor may be quantized, i.e. continuous-valued data may be mapped to a finite set of discrete values, which introduces an error as explained further in the section Autoencoders and unsupervised learning.

As discussed above, a masked convolution may be applied to each of the elements within a patch. The masked convolution is applied on each patch independently. Such a masked convolution kernel as shown in FIG. 5 convolves the current element and subsequent elements in the encoding order (which is typically the same as the decoding order) within said patch with zero. This masks the latent tensor elements that have not been encoded yet; therefore, subsequent convolution operations act on the previously coded tensor elements. The output tensor of masked convolutions is denoted by ϕ. During encoding, all latent tensor elements are available, thus masked convolutions guarantee that the causality of the coding sequence is not disturbed.

An empty matrix entry in FIG. 5 refers to an arbitrary value, which may be learned during the training of the neural network. For example, a convolution operation 5010 applied on each latent tensor element y(i, j) means multiplying all the neighboring elements in 3×3 grid multiplied by the respective elements of the 3×3 kernel 5010 and adds the products to obtain a single tensor element ϕ(i, j). Here, i and j are the relative spatial indices in each patch.

For a K×L grid of patches the tensor ϕ(i, j, k, l) is obtained. Here, k and l are the indices in the patch grid. The elements of this tensor represent the information being shared between the adjoined elements of a respective current element within each single patch. The notation ϕ(i, j, k, l) omits the channel dimension C_{ϕ} and refers to the four dimensions P_{H}×P_{W}×N_{patch,H}×N_{patch,W} of the five dimensional tensor ϕ, where the number of patches is represented by the two indices k and l.

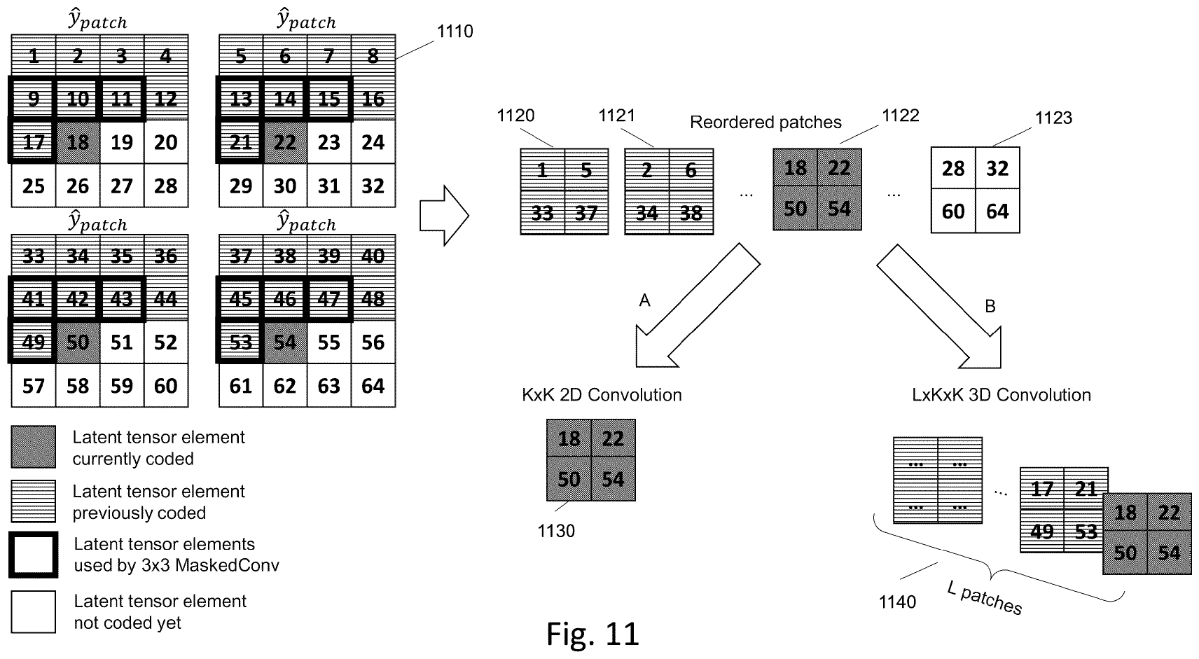

After the masked convolutions process each patch in parallel, the reordering block 1030 may be applied on the masked latent tensor ϕ split into patches 1110. The reordering operation is illustrated in FIG. 11. The reordering block rearranges latent tensor elements such that the co-located tensor elements from different patches are projected onto the same spatial plane. The reordering allows that mathematical operations such as convolutions are efficiently applicable on the co-located tensor elements. The example in FIG. 11 reorders the co-located elements of the four patches 1110 into the reordered patches 1120-1132.

In the first step of obtaining an optional hyper-prior model, a hyper-encoder 320 may be applied to the latent tensor to obtain a hyper-latent tensor. The hyper-latent tensor may be encoded into a second bitstream, for example the z bitstream 341. The second bitstream may be entropy decoded and a hyper-decoder output is obtained by hyper-decoding the hyper-latent tensor. The hyper-prior model may be obtained as explained in section Variational image compression. However, the present disclosure is not limited to this example.

Similarly, an output of the optional hyper-decoder may be separated into a plurality of patches 1011. A reordering may be applied to the hyper-decoder output patches by a reordering block 1031. The hyper-decoder output patches may be concatenated with the patches of the latent tensor. In the case, when a reordering has been performed, the reordered patches of the latent tensor and the reordered patches of the hyper-decoder output are concatenated. The concatenating 1040 in the channel dimension of the reordered tensors ϕ and ψ results in a concatenated 4D tensor with the size of N_{patch,H}×N_{patch,W} (C_{ϕ}+C_{ψ})×(P_{H}·P_{W}), where C_{ϕ} and C_{ψ} are the number of channels of the tensor and IP, respectively.

For sharing information 1050 between patches for entropy estimation a set of elements of the latent tensor, which are co-located in a subset of patches, are processed by applying a convolution kernel. A probability model for the encoding of a current element is obtained based on the processed set of elements. The subset of patches may form a K×M grid within the N_{patch,H}×N_{patch,W} grid of all patches, K and M being positive integers and at least one of K and M being larger than one.

The set of elements in a first embodiment may have dimensions K×M, corresponding to the K×M subset of patches. The set may include one element per patch within the subset of patches and the one element is the current element (currently processed element). This set may have been reordered by the above explained reordering forming the reordered patch of current elements 1130.

In order to share information between patches, the convolution kernel may be a two-dimensional B×C convolution kernel, B and C being positive integers and at least one of B and C being larger than one, which is applied to the set of current elements 1130. B and C may be identical to K and M, respectively, or different from K and M. The two-dimensional B×C convolution kernel may be applied as a part of a multi-layer two-dimensional B×C convolutional neural network with non-linear transformations, which are applied to the first three dimensions of the concatenated tensor. In other words, the two-dimensional B×C convolution kernel may be applied to 2D feature elements, each belonging to a respective patch.

In the example of FIG. 11 a two-dimensional K×K convolution kernel is applied to the reordered patch of current elements 18, 22, 50 and 54.

The size of the convolution kernel is not restricted to the dimension of the reordered tensor. The kernel may be bigger than the set of elements, which can be padded analogously to the latent tensor, as explained above.

For example, having a 4×3 subset of patches and a corresponding set of co-located elements (e.g. first element) of each patch, the convolution kernel may have arbitrary B×C, where B>1 and C>1, e.g. 3×3, 3×5, or the like. In addition, B=1 and C>1 or B>1 and C=1 may be possible, which enables horizontally or vertically sharing of information.

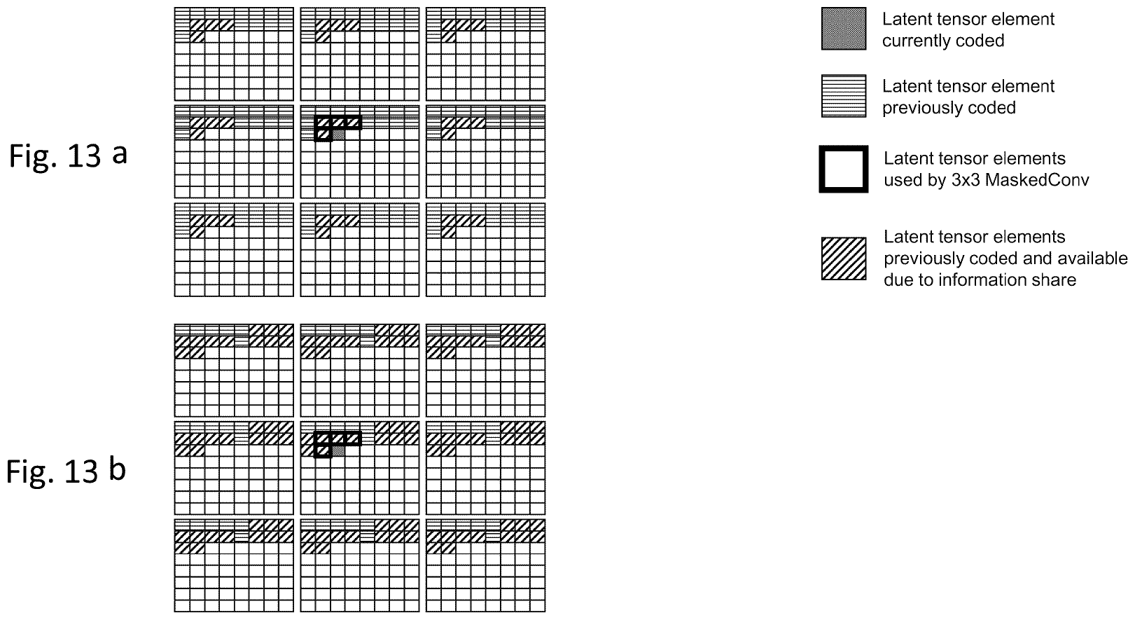

By applying such a two-dimensional convolution, information is shared between patches as it is illustrated in FIG. 13a. In this example, a 3×3 convolution is applied to a set of 3×3 current elements. Thus, the current element of the patch in the center receives information of the four adjoining elements of each of the respective current elements. Without the additional convolution, the element would receive information from its own four adjoining patches. The number of adjoining elements, which are considered, depends on the dimension of the masked convolution. In this example a 3×3 masked convolution kernel 5010 is used.

The set of elements in a second embodiment may have dimensions L×K×M, corresponding to the K×M subset of patches. The set may include L elements per patch within the subset of patches including the current element and one or more previously encoded elements, L being an integer larger than one. This set may have been reordered by the above explained reordering forming the L reordered patches of current and previous elements 1140, as it is shown in FIG. 11. The first embodiment can be seen as performing a convolution in spatial domain (over the elements from a plurality of patches that are currently encoded). On the other hand, the second embodiment can be seen as performing a convolution in spatial and temporal (or spatio-temporal) domain (over the elements from a subset of patches that are currently encoded and over the “historical” elements from the subset of patches that have been previously encoded).

In order to share information between patches, the convolution kernel in the second embodiment may be, in general, a three-dimensional A×B×C convolution kernel, A being an integer larger than one and B and C being positive integers and at least one of B and C being larger than one, which is applied to the set of current elements 1140. B and C may be identical to K and M or different from K and M. The three-dimensional A×B×C convolution kernel may be applied to all four dimensions of the concatenated tensor. The application of the three-dimensional A×B×C convolution kernel may be followed by a multi-layer convolutional neural (sub-)network, which may include one or more three-dimensional A×B×C convolutional kernels and/or one or more two-dimensional B×C convolutional kernels with non-linear transformations. A three-dimensional A×B×C convolutional kernel is applied to the four dimensions of the concatenated 4D tensor, a two-dimensional B×C convolutional kernel is applied to the first three dimensions of the concatenated 4D tensor.

In the example of FIG. 11 a three-dimensional L×K×K convolution kernel is applied to the L reordered patches including a patch of current elements 18, 22, 50 and 54, a first patch of previous elements 17, 21, 49 and 53, a second patch of previous elements 12, 16, 44 and 48, and so on.

The size of the convolution kernel is not restricted to the dimension of the reordered tensor. The kernel may be bigger than the set of elements, which can be padded analogously to the latent tensor, as explained above.

For example, having a 12×8 subset of patches with each patch having the size of 8×8, with total of 64 elements, the set of elements may have the dimensions of 64×12×8 elements.

The convolutional kernel can be arbitrary for the last 2 dimension as explained with respect to the first embodiment. However, for the first dimension the kernel size should be larger than 1, and smaller or equal to 64 (number of elements within the patch), for this example.

In addition, B=1 and C>1 or B>1 and C=1 may be possible, which enables horizontally or vertically sharing of information. In a case with A=1, no information will be shared in the additional dimension. So for the case A=1, the second embodiment is identical to the first embodiment.

By applying such a three-dimensional convolution, information is shared between patches as it is illustrated in FIG. 13b. In this example, a 5×3×3 convolution is applied to a set of elements, which includes a 3×3 subset of current elements and four 3×3 subsets of previously coded elements. Thus, the current element of the patch in the center receives information of the four adjoining elements of each of the respective current elements and the four adjoining elements of each of the respective previous elements. Without the additional convolution, the element would receive information from its own four adjoining patches. The number of adjoining elements, which are considered, depends on the dimension of the masked convolution. In this example a 3×3 masked convolution kernel 5010 is used.

The convolution kernels used in the one or more layers of the neural network may be trainable as discussed in the section Autoencoders and unsupervised learning. For example, in the training phase, the kernels are trained and the trained kernels are applied during the inference phase. It is possible to perform also online training during the inference phase. In other words, the present disclosure is not limited to any particular training approach. In general, training may help adapting the neural network(s) for a particular application.

A historical memory 1060 may store the previously encoded elements. The information of these previously encoded elements may be supplied to the information sharing process 1050. This may be particularly relevant for the above-mentioned second embodiment, which also processes elements from previously coded (encoded and/or decoded) elements.

After information sharing, the elements may be further processed, for example by gathering 1070 and entropy modelling 1080, to obtain an entropy model for the encoding of the current element as explained above.

The current element may be encoded in a first bitstream, for example they bitstream of FIG. 6, using the obtained probability model for the entropy encoding. A specific implementation for entropy encoding may be, for example, arithmetic encoding, which is discussed in the section Variational image compression.

The probability model for the encoding of the current element may be selected using (i) information of co-located elements that are currently to be encoded (first embodiment) or (ii) information of co-located current elements and information of co-located elements that have been previously encoded (second embodiment). The term “co-located” here means that the respective elements have the same relative spatial coordinates within the respective patch.

Said selection of the probability model may be made according to (i) information about previously encoded elements, and/or (ii) an exhaustive search, and/or (iii) properties of the first bitstream.

The information about previously encoded elements may include statistical properties, for example, variance (or another statistical moment) or may include the number of elements that have been processed before.

In an exhaustive search, the encoder may try each option whether or not including the information about previously encoded elements and may measure the performance. An indication, which option is used, may be signaled to the decoder.

Properties of the first bitstream may include a predefined target rate or a frame size. A set of rules, which option to use may be predefined. In this case, the rules may be known by the decoder, thus additional signaling is not required.

The applying of the convolution kernel, which may include the masked convolutions and/or the sharing of information, as well as the entropy encoding of the current element may be performed in parallel for each patch out of the plurality of patches. Furthermore, during encoding all latent tensor elements are available, thus the sharing of information may be performed in parallel for each element of the latent tensor as the masked convolutions may guarantee a correct ordering for the coding sequence.

The probability model using shared information between patches may be applied to the entropy encoding of a latent tensor obtained from an autoencoding convolutional neural network as discussed above.

For decoding of the latent-space feature tensor from a first bitstream the latent tensor is initialized with zeroes, as the decoder is agnostic to the latent tensor and its statistical properties. For a possible parallelization as at the encoder side, the latent-space feature tensor, which includes one or more elements, is separated into a plurality of patches 1010, each patch including one or more latent tensor elements. Such a plurality of patches is processed by one or more layers of a neural network. The patch size may be extracted from the first bitstream. The patches may be non-overlapping and each patch out of the plurality of patches may be of a same patch size P_{H}×P_{W}.

In order to obtain patches of the same size the latent tensor may be padded such that the new size of the latent tensor is a multiple of the patch size before separating the latent tensor into patches. The padding may be performed analogously to the encoding side, which is explained above. The latent tensor may be padded with zeroes. Analogously to the encoding side, padding by zeros is merely one option. Padding may be performed by bits or symbols of any value or by a repetition of latent tensor elements. Given the original image size H and W, and the patch size that may have been extracted from the first bitstream, the size of the area, which should be padded, can be calculated on the decoder side in a similar way as at the encoder side.

A reordering block 1030 may be applied on the latent tensor split into patches 1110. The reordering block rearranges latent tensor elements such that the co-located tensor elements from different patches are projected onto the same spatial plane, which is illustrated in FIG. 11. The reordering simplifies the application of mathematical operations such as convolutions on the co-located tensor elements. The example in FIG. 11 reorders the co-located elements of the four patches 1110 into the reordered patches 1120-1132.

A hyper-latent tensor may be entropy decoded from a second bitstream. The obtained hyper-latent tensor may be hyper-decoded into a hyper-decoder output ψ.

Corresponding to the encoding side, an output of the optional hyper-decoder ψ may be separated into a plurality of patches 1011 and reordering may be applied to the hyper-decoder output patches by a reordering block 1031. The hyper-decoder output patches may be concatenated with the patches of the latent tensor. If a reordering has been performed, the reordered patches of the latent tensor and the reordered patches of the hyper-decoder output are concatenated. The concatenating 1040 in the channel dimension of the reordered tensors ϕ and ψ results in a concatenated 4D tensor with the size of N_{patch,H}×N_{patch,W} (C_{ϕ}+C_{ψ})×(P_{H}·P_{W}), where C_{ϕ} and C_{ψ} are the number of channels of the tensor ϕ and ψ, respectively.

For sharing information 1050 between patches for entropy estimation a set of elements of the latent tensor, which are co-located in a subset of patches, are processed by applying a convolution kernel. A probability model for the encoding of a current element is obtained based on the processed set of elements.

The convolution kernel may be a two-dimensional convolution kernel as defined in the spatial method of the first embodiment, which may be applied to the set of elements within the subset of patches having dimensions as defined at the encoding side. Said two-dimensional convolution kernel may be part of a multi-layer two-dimensional convolutional neural network with non-linear transformations.

The convolution kernel may be a three-dimensional convolution kernel as defined in the spatio-temporal method of the second embodiment, which may be applied to the set of elements within the subset of patches having dimensions as defined at the encoding side. The application of the three-dimensional convolution kernel may be followed by a multi-layer convolutional neural (sub-)network, as explained above for the encoding side.

The process of sharing information between patches by applying a convolution kernel according to the spatial method or the spatio-temporal method is explained in detail for the encoding side and works analogously at the decoding side.

The convolution kernels used in the one or more layers of the neural network may be trainable as discussed in the section Autoencoders and unsupervised learning. As mentioned above, the present disclosure is not limited to any particular training approach. During the training phase, the encoding and the decoding may be performed in order to determine the weights of the autoencoding neural network and/or the weights of the neural network for the autoregressive entropy estimation. The autoencoding neural network and the neural network for the entropy estimation may be trained together or independently. After training, the obtained weights may be signaled to the decoder. In the case of continuous fine-tuning or online training, the encoder probability model may be (further) trained during encoding and the updated weights of the probability model may be additionally signaled to the decoder, e.g. regularly. The weights may be compressed (quantized and/or entropy coded) before including them into the bitstream. The entropy coding for the weight tensor may be optimized in a similar way as for the latent tensor.

A historical memory 1060 may store the previously encoded elements. The information of these previously encoded elements may be supplied to the information sharing process 1050. This may be particularly relevant for the above-mentioned spatio-temporal method, which also processes elements from previously coded (encoded and/or decoded) elements.

The current element may be decoded from the first bitstream, for example the y bitstream of FIG. 6, using the obtained probability model for the entropy decoding. A specific implementation for entropy decoding may be, for example, arithmetic encoding, which is discussed in the section Variational image compression.

The probability model for the encoding of the current element may be determined using (i) information of co-located elements that are currently to be decoded (spatial method, two-dimensional convolution kernel) or (ii) information of co-located current elements and information of co-located elements that have been previously decoded (spatiao-temporal method, three-dimensional convolution kernel).

Said determination of the probability model may be made according to (i) information about previously encoded elements, and/or (ii) properties of the first bitstream.

The information about previously encoded elements may include statistical properties, for example, variance (or another statistical moment) or may include the number of elements that have been processed before.

If an exhaustive search may have been performed at the encoder, the decoder may receive an indication, which option has been used.

Properties of the first bitstream may include a predefined target rate or a frame size. A set of rules, which option to use may be predefined. In this case, the rules may be known by the decoder.

The applying of the convolution kernel, which may include the sharing of information, as well as the entropy decoding of the current element may be performed in parallel for each patch out of the plurality of patches. During decoding the autoregressive entropy estimation 360 and the entropy decoding 372 are repeated for each element within a single patch sequentially.

The probability model using shared information between patches may be applied to the entropy decoding of a latent tensor that may be processed by an autodecoding convolutional neural network to obtain image data as discussed above.

Implementation within Picture Coding

The encoder 20 may be configured to receive a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RGB format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 color format.

Implementations in Hardware and Software

Some further implementations in hardware and software are described in the following.

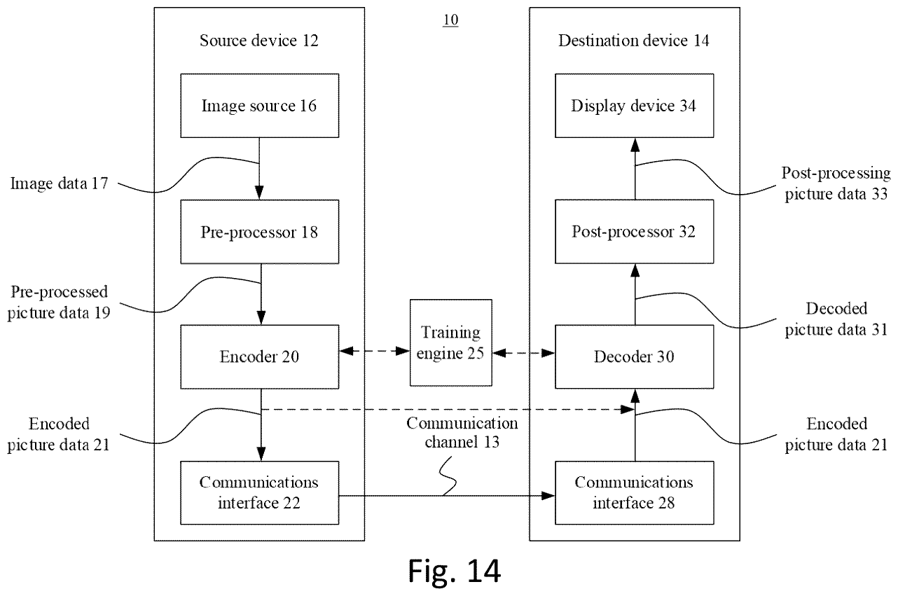

Any of the encoding devices described with references to FIGS. 14-17 may provide means in order to carry out the entropy encoding of a latent tensor. A processing circuitry within any of these devices is configured to separate the latent tensor into a plurality of patches, each patch including one or more elements, process the plurality of patches by one or more layers of a neural network, including processing a set of elements which are co-located in a subset of patches by applying a convolution kernel, and obtain a probability model for the entropy encoding of a current element of the latent tensor based on the processed set of elements.

The decoding devices in any of FIGS. 14-17, may contain a processing circuitry, which is adapted to perform the decoding method. The method as described above comprises the initialization of the latent tensor with zeroes, the separation of the latent tensor into a plurality of patches, each patch including one or more elements, the processing of the plurality of patches by one or more layers of a neural network, including the processing of a set of elements which are co-located in a subset of patches by applying a convolution kernel, and the obtaining of a probability model for the entropy decoding of a current element of the latent tensor based on the processed set of elements.

Summarizing, methods and apparatuses are described for entropy encoding and decoding of a latent tensor, which includes separating the latent tensor into patches and obtaining a probability model for the entropy encoding of a current element of the latent tensor by processing a set of elements from different patches by one or more layers of a neural network. The processing of the set of elements by applying a convolution kernel enables sharing of information between the separated patches.

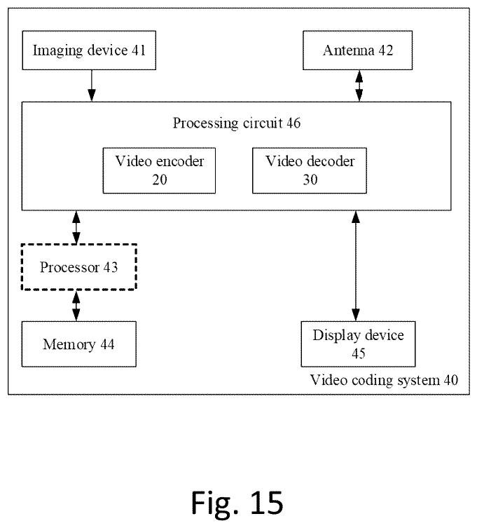

In the following embodiments of a video coding system 10, a video encoder 20 and a video decoder 30 are described based on FIGS. 14 and 15.

FIG. 14 is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 14, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 14 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

The coding system 10 further includes a training engine 25. The training engine 25 is configured to train the encoder 20 (or modules within the encoder 20) or the decoder 30 (or modules within the decoder 30) to process an input picture or generate a probability model for entropy encoding as discussed above.

Although FIG. 14 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 14 may vary depending on the actual device and application.

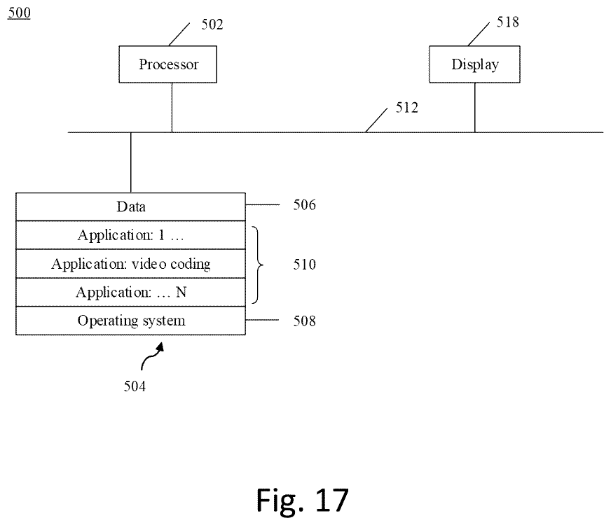

The encoder 20 (e.g. a video encoder 20) or the decoder 30 (e.g. a video decoder 30) or both encoder 20 and decoder 30 may be implemented via processing circuitry as shown in FIG. 15, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder of FIG. 3b and/or any other encoder system or subsystem described herein. The decoder 30 may be implemented via processing circuitry 46 to embody the various modules as discussed with respect to decoder of FIG. 3c and/or any other decoder system or subsystem described herein. The processing circuitry may be configured to perform the various operations as discussed later. As shown in FIG. 17, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 15.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 14 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the invention are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the invention are not limited to HEVC or VVC.

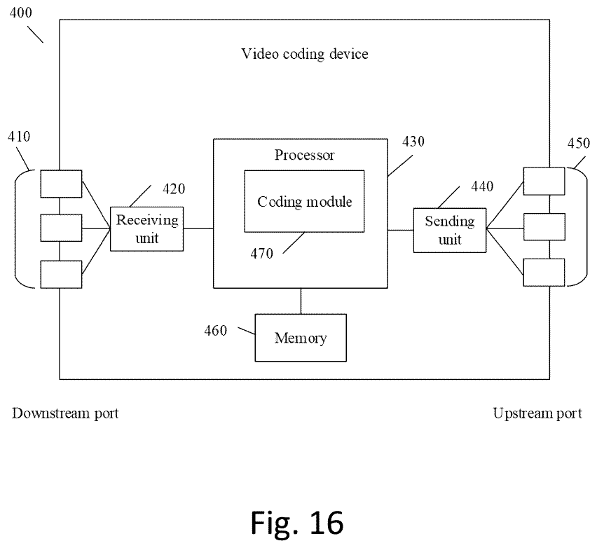

FIG. 16 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 14 or an encoder such as video encoder 20 of FIG. 14.

The video coding device 400 comprises ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

FIG. 17 is a simplified block diagram of an apparatus 500 that may be used as either or both of the source device 12 and the destination device 14 from FIG. 14 according to an embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described herein, including the encoding and decoding using a neural network with a subset of partially updatable layers.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

Although embodiments of the invention have been primarily described based on video coding, it should be noted that embodiments of the coding system 10, encoder 20 and decoder 30 (and correspondingly the system 10) and the other embodiments described herein may also be configured for still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (also referred to as tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory, or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

What is claimed is:

1. A method for entropy encoding of a latent tensor, comprising:
separating the latent tensor into a plurality of patches each patch including one or more elements;
processing the plurality of patches by one or more layers of a neural network, including processing a set of elements which are co-located in a subset of patches by applying a convolution kernel; and
obtaining a probability model for the entropy encoding of a current element of the latent tensor based on the processed set of elements.

2. The method according to claim 1, wherein
the subset of patches forms a K×M grid of patches, with K and M being positive integers, at least one of K and M being greater than one;
the set of elements has dimensions K×M corresponding to the K×M grid of patches and includes one element per patch within the subset of patches, and the one element is the current element; and
the convolution kernel is a two-dimensional B×C convolution kernel, with B and C being positive integers, at least one of B and C being greater than one.

3. The method according to claim 1, wherein
the subset of patches forms a K×M grid of patches, with K and M being positive integers, at least one of K and M being greater than one;
the set of elements has dimensions Lx K×M corresponding to the K×M grid of patches and includes L elements per patch including the current element and one or more previously encoded elements, wherein L is an integer greater than one; and
the convolution kernel is three-dimensional A×B×C convolution kernel, with A being an integer greater than one and B and C being positive integers, at least one of B and C being greater than one, and
wherein the method further comprises:
storing the previously encoded elements in a historical memory.

4. The method according to claim 1, further comprising:
reordering the elements included in the set of elements which are co-located in the subset of patches by projecting the co-located elements according to a respective patch position within the subset of patches onto a same spatial plane before the processing.

5. The method according to claim 1, wherein the convolution kernel is trainable within the neural network.

6. The method according to claim 1, further comprising:
applying a masked convolution to each of the elements included in a patch out of the plurality of patches, which convolutes the current element and subsequent elements in the encoding order within the patch with zero.

7. The method according to claim 1, further comprising:
entropy encoding the current element into a first bitstream using the obtained probability model, and
wherein the method further comprises:
including the patch size into the first bitstream.

8. The method according to claim 1, wherein patches within the plurality of patches are non-overlapping and each patch out of the plurality of patches is of a same patch size,
wherein the method further comprises:
padding the latent tensor such that a new size of the latent tensor is a multiple of the same patch size before separating the latent tensor into the plurality of patches, and
wherein the latent tensor is padded by zeroes.

9. The method according to claim 1, further comprising:
quantizing the latent tensor before separating into patches.

10. A method for encoding image data comprising:
obtaining a latent tensor by processing the image data with an autoencoding convolutional neural network; and
entropy encoding the latent tensor into a bitstream using a generated probability model according to claim 1.

11. A method for entropy decoding of a latent tensor, comprising:
initializing the latent tensor with zeroes;
separating the latent tensor into a plurality of patches, each patch including one or more elements;
processing the plurality of patches by one or more layers of a neural network, including processing a set of elements which are co-located in a subset of patches by applying a convolution kernel;
obtaining a probability model for the entropy decoding of a current element of the latent tensor based on the processed set of elements.

12. The method according to claim 11, wherein
the subset of patches forms a K×M grid of patches, with K and M being positive integers, at least one of K and M being greater than one;
the set of elements has dimensions K×M corresponding to the K×M grid of patches and includes one element per patch within the subset of patches, and the one element is the current element; and
the convolution kernel is a two-dimensional B×C convolution kernel, with B and C being positive integers, at least one of B and C being greater than one.

13. The method according to claim 11, wherein
the subset of patches forms a K×M grid of patches, with K and M being positive integers, at least one of K and M being greater than one;
the set of elements has dimensions L×K×M corresponding to the K×M grid of patches and includes L elements per patch including the current element and one or more previously encoded elements, wherein L is an integer greater than one; and
the convolution kernel is three-dimensional A×B×C convolution kernel, with A being an integer greater than one and B and C being positive integers, at least one of B and C being greater than one; and
wherein the method further comprises:
storing of the previously decoded elements in a historical memory.

14. The method according to claim 11, further comprising:
reordering the elements included in the set of elements which are co-located in the subset of patches by projecting the co-located elements according to a respective patch position within the subset of patches onto a same spatial plane before the processing.

15. The method according to claim 11, wherein the convolution kernel is trainable within the neural network.

16. The method according to claim 11, further comprising:
entropy decoding the current element from a first bitstream using the obtained probability model, and
wherein the method further comprises:
extracting the patch size from the first bitstream.

17. The method according to claim 11, wherein patches within the plurality of patches are non-overlapping and each patch out of the plurality of patches is of a same patch size,
wherein the method further comprises:
padding the latent tensor such that a new size of the latent tensor is a multiple of the same patch size before separating the latent tensor into the plurality of patches, and
wherein the latent tensor is padded by zeroes.

18. The method according to claim 16, further comprising:
determining the probability model for the entropy decoding using:
information of co-located elements that are currently to be decoded, or
information of co-located current elements and information of co-located elements that have been previously decoded, and
wherein the method further comprises:
determining the probability model according to:
information about previously decoded elements, and/or
properties of the first bitstream.

19. The method according to claim 11, further comprising:
entropy decoding a hyper-latent tensor from a second bitstream;
obtaining a hyper-decoder output by hyper-decoding the hyper-latent tensor; and
wherein the method further comprises:
separating the hyper-decoder output into a plurality of hyper-decoder output patches, each hyper-decoder output patch including one or more hyper-decoder output elements;
concatenating a hyper-decoder output patch out of the plurality of hyper-decoder output patches and a corresponding patch out of the plurality of patches before the processing; and
reordering the hyper-decoder output elements included in the set of elements which are co-located in the subset of patches by projecting the co-located elements onto the same spatial plane.

20. The method according to claim 11, wherein one or more of the following are performed in parallel for each patch out of the plurality of patches:
applying the convolution kernel, and
entropy decoding the current element.

21. A method for decoding image data comprising:
entropy decoding a latent tensor from a bitstream according to claim 11; and
obtaining the image data by processing the latent tensor with an autodecoding convolutional neural network.

22. A non-transitory computer readable medium having code instructions stored thereon, which, upon execution by one or more processors, cause the one or more processors to execute the method according to claim 1.

23. An apparatus for entropy encoding of a latent tensor, comprising:
a processing circuitry configured to:
separate the latent tensor into a plurality of patches, each patch including one or more elements;
process the plurality of patches by one or more layers of a neural network, including processing a set of elements which are co-located in a subset of patches by applying a convolution kernel; and
obtain a probability model for the entropy encoding of a current element of the latent tensor based on the processed set of elements.

24. An apparatus for entropy decoding of a latent tensor, comprising:
a processing circuitry configured to:
initialize the latent tensor with zeroes;
separate the latent tensor into a plurality of patches, each patch including one or more elements;
process the plurality of patches by one or more layers of a neural network, including processing a set of elements which are co-located in a subset of patches by applying a convolution kernel;
obtain a probability model for the entropy decoding of a current element of the latent tensor based on the processed set of elements.
